(19) United States
(12) Patent Application Publication
(10) Pub. No.: US 2026/0032529 A1
(43) Pub. Date: Jan. 29, 2026

(54) SUCCESSIVE CONDITIONAL CELL SWITCH

(71) Applicant: Samsung Electronics Co., Ltd., Suwon-si (KR)

(72) Inventors: Shiyang Leng, Little Elm, TX (US); Anil Agiwal, McKinney, TX (US); Kyeongin Jeong, Frisco, TX (US)

(21) Appl. No.: 19/271,634

(22) Filed: Jul. 16, 2025

Related U.S. Application Data
(60) Provisional application No. 63/676,718, filed on Jul. 29, 2024.

(51) Int. Cl. H04W 36/00; H04B 7/06

(52) U.S. Cl. CPC H04W 36/0061; H04B 7/06952; H04W 36/0085

(57) ABSTRACT

Disclosed is a cell switch mechanism that enables successive conditional handover without configuration release or reconfiguration between cell switch executions. A UE receives from a source base station a cell switch configuration for a plurality of candidate cells. The cell switch configuration includes conditional events associated with a respective one of the plurality of candidate cells. The UE determines whether the conditional events associated with at least one cell from the plurality of candidate cells are fulfilled when the UE is connected to the source base station. The UE triggers a cell switch to connect to a first target cell from the plurality of candidate cells when the conditional events associated with the first target cell are fulfilled. The UE determines whether to switch from the first target cell to a second target cell from the plurality of candidate cells based on the cell switch configuration for the candidate cells.

### CROSS-REFERENCE TO RELATED APPLICATIONS

This application claims the benefit of priority from U.S. Provisional Application No. 63/676,715 entitled “SUBSEQUENT CONDITIONAL CELL SWITCH,” filed Jul. 29, 2024, which is incorporated herein by reference in its entirety.

### TECHNICAL FIELD

This disclosure relates generally to a wireless communication system, and more particularly to mechanisms to support cell switching by a user equipment (UE) when the UE experiences a degraded connection to a serving cell in fast mobility scenarios.

### BACKGROUND

3GPP (Third-Generation Partnership Project) has developed technical specifications and standards to define the new 5G radio-access technology, known as 5G NR (New Radio) and the upcoming technology currently coined “6G.” Mobility handling is a critical aspect in any mobile communication system including 5G or 6G systems. For a UE (User Equipment) in connected mode, the network may control mobility handling with assistance from the UE to maintain a good quality of connection through the provision of mobility-related mechanisms and procedures. Based on the measurement on radio link quality of the serving cell and neighboring cell(s) reported by the UE, the network may hand over the UE to a neighboring cell that can provide better radio conditions when the UE is experiencing a degraded connection to the serving cell.

To mitigate connection interruption during a handover procedure, 5G system introduces enhancements to network-controlled mobility in connected mode, including the conditional handover (CHO) procedure. The CHO procedure provides one or more trigger conditions to be evaluated by the UE. Upon the satisfaction of a trigger condition, the UE switches from the source cell to a target cell configured by the base station of the serving cell. The UE may perform the execution of the CHO procedure without involvement of the 5C core network.

To reduce the mobility latency in high-speed UE or in millimeter-wave range deployment scenarios (e.g., frequency range 2 (FR2)), 5G system also introduces L1/L2 triggered mobility (LTM), by which handover may be triggered by L1/L2 signaling based on L1 measurement. LTM refers to a mobility mechanism by which the UE switches from the source cell to a target cell with beam and cell switching triggered by L1/L2 signaling, where the UE makes the beam and cell switching decision based on L1 measurement on beams among neighboring cells.

In fast mobility scenarios, for instance in non-terrestrial network (NTN) where satellites move fast, and in terrestrial network (TN) where a UE moves fast, successive cell switches may happen. For CHO, serving base station and target/candidate base station(s) have to initiate the preparation procedure via inter-node message exchange and configure CHO by sending radio resource control (RRC) reconfiguration message to the UE for each CHO operation. This signaling overhead slows down successive cell switch and causes more signaling and delay. While LTM may be used to reduce the mobility latency, LTM relies on cell switch commands from the serving base station. To reduce signaling overhead and delay, and to improve handover reliability in TN and/or NTN fast mobility scenarios, it is desired to have a new handover mechanism.

While the background section provides a motivation for the present disclosure, the description set forth in the background section should not be assumed to be prior art merely because it is set forth in the background section. Rather, the background section may describe aspects or embodiments of the present disclosure.

### SUMMARY

An aspect of the present disclosure provides for a user equipment (UE) in a wireless network. The UE includes a processor configured to receive from a cell of a source base station a cell switch configuration for a plurality of candidate cells. The cell switch configuration include one or more conditional events associated with a respective one of the plurality of candidate cells. The processor is also configured to determine whether the conditional events associated with at least one candidate cell from the plurality of candidate cells are fulfilled when the UE is connected to the source base station. The processor is further configured to trigger a cell switch to connect to a first target cell from the plurality of candidate cells when the conditional events associated with the first target cell are fulfilled. The processor is further configured to determine whether to switch from the first target cell to a second target cell from the plurality of candidate cells based on the cell switch configuration for the plurality of candidate cells.

In one embodiment, the cell switch configuration includes the conditional events associated with the first target cell and the conditional events associated with the second target cell. To determine whether to switch from the first target cell to the second target cell, the processor is configured to determine whether the conditional events associated with the second target cell are fulfilled when the UE is connected to the first target cell.

In one embodiment, the conditional events associated with a candidate cell of the plurality of candidate cells includes at least one of: a beam measurement event of the candidate cell; a location event of the candidate cell; or a time event of the candidate cell.

In one embodiment, the beam measurement event of the candidate cell includes: a beam measurement of the candidate cell is better than a beam measurement of a connected cell of the UE by a configured amount; the beam measurement of the candidate cell is better than a first configured threshold; or the beam measurement of the connected cell of the UE is worse than a second configured threshold and the beam measurement of the candidate cell is better than a third configured threshold.

In one embodiment, to determine whether the conditional events associated with the at least one candidate cell are fulfilled, the processor is configured to receive from the cell of the source base station a measurement configuration for a resource of the at least one candidate cell. The processor is further configured to determine whether a measurement of the resource of the at least one candidate cell based on the measurement configuration satisfies the beam measurement event of the at least one candidate cell.

In one embodiment, the location event of the candidate cell includes: a distance measurement of the UE from a reference location is larger than a first configured distance threshold and a distance measurement of the UE from the candidate cell is less than a second configured distance threshold; a distance measurement of the UE from a moving location of a connected cell of the UE is larger than a third configured distance threshold and a distance measurement of the UE from a moving location of the candidate cell is less than a fourth configured distance threshold; a distance measurement of the UE from a reference location of the candidate cell is less than a fifth configured distance threshold; or a distance measurement of the UE from the moving location of the candidate cell is less than a sixth configured distance threshold.

In one embodiment, the time event of the candidate cell includes a measured time of the UE is more than a configured time threshold and the measured time is less than a sum of the configured time threshold and a configured duration.

In one embodiment, the source base station and the plurality of candidate cells are part of a non-terrestrial network.

In one embodiment, the processor is further configured to perform a downlink or an uplink synchronization with a candidate cell of the plurality of candidate cells before the cell switch.

An aspect of the present disclosure provides a method performed by a UE in a wireless network. The method includes the UE receiving, from a cell of a source base station a cell, switch configuration for a plurality of candidate cells. The cell switch configuration includes one or more conditional events associated with a respective one of the plurality of candidate cells. The method also includes the UE determining whether the conditional events associated with at least one candidate cell from the plurality of candidate cells are fulfilled when the UE is connected to the source base station. The method further includes the UE triggering a cell switch to connect to a first target cell from the plurality of candidate cells when the conditional events associated with the first target cell are fulfilled. The method further includes the UE determining whether to switch from the first target cell to a second target cell from the plurality of candidate cells based on the cell switch configuration for the plurality of candidate cells.

In one embodiment of the method, cell switch configuration includes the conditional events associated with the first target cell and the conditional events associated with the second target cell. When determining whether to switch from the first target cell to the second target cell, the method includes the UE determining whether the conditional events associated with the second target cell are fulfilled when the UE is connected to the first target cell.

In one embodiment of the method, the conditional events associated with a candidate cell of the plurality of candidate cells includes at least one of: a beam measurement event of the candidate cell; a location event of the candidate cell; or a time event of the candidate cell.

In one embodiment of the method, the beam measurement event of the candidate cell includes: a beam measurement of the candidate cell is better than a beam measurement of a connected cell of the UE by a configured amount; the beam measurement of the candidate cell is better than a first configured threshold; or the beam measurement of the connected cell of the UE is worse than a second configured threshold and the beam measurement of the candidate cell is better than a third configured threshold.

In one embodiment of the method, when determining whether the conditional events associated with the at least one candidate cell are fulfilled, the method includes the UE receiving, from the cell of the source base station, a measurement configuration for a resource of the at least one candidate cell. The method further includes the UE determining whether a measurement of the resource of the at least one candidate cell based on the measurement configuration satisfies the beam measurement event of the at least one candidate cell.

In one embodiment of the method, the location event of the candidate cell includes: a distance measurement of the UE from a reference location is larger than a first configured distance threshold and a distance measurement of the UE from the candidate cell is less than a second configured distance threshold; a distance measurement of the UE from a moving location of a connected cell of the UE is larger than a third configured distance threshold and a distance measurement of the UE from a moving location of the candidate cell is less than a fourth configured distance threshold; a distance measurement of the UE from a reference location of the candidate cell is less than a fifth configured distance threshold; or a distance measurement of the UE from the moving location of the candidate cell is less than a sixth configured distance threshold.

In one embodiment of the method, the time event of the candidate cell includes a measured time of the UE is more than a configured time threshold and the measured time is less than a sum of the configured time threshold and a configured duration.

In one embodiment of the method, the source base station and the plurality of candidate cells are part of a non-terrestrial network.

In one embodiment, the method further includes the UE performing a downlink or an uplink synchronization with a candidate cell of the plurality of candidate cells before the cell switch.

An aspect of the present disclosure provides for a base station in a wireless network. The base station includes a transceiver configured to transmit to a plurality of candidate cells a request for cell switch configurations respective to the plurality of candidate cells. The transceiver is also configured to receive from the plurality of candidate cells the cell switch configurations. The transceiver is further configured to transmit to a UE a reconfiguration message based on the cell switch configurations. The reconfiguration message includes one or more conditional events associated with a respective one of the plurality of candidate cells to enable the UE to switch successively to a plurality of target cells from the plurality of candidate cells based on fulfilling the conditional events associated with a respective one of the plurality of target cells.

In one embodiment, the reconfiguration message includes conditional events associated respectively with a first target cell and a second target cell from the plurality of candidate cells. The conditional events associated with the first target cell enables the UE to switch to the first target cell when the UE is connected with the base station, The conditional events associated with the second target cell enables the UE to switch to the second target cell when the UE is connected with the first target cell.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows the signalling diagram for the basic CHO scenario where neither the access and mobility management function (AMF) nor the user plane function (UPF) changes.

FIG. 5 shows the signalling diagram between a UE and a source gNB for the LTM procedure.

FIG. 6 shows the signalling diagram for successive conditional cell switching in accordance with an embodiment.

FIG. 7 shows an example process 700 for a UE that evaluates execution conditions for multiple candidate cells and executes successive cell switch to multiple candidate cells autonomously when the corresponding execution conditions are met in accordance with an embodiment.

FIG. 8 shows an example process 800 for a base station to configure a UE with execution conditions for multiple candidate cells to enable the UE to execute successive cell switch in accordance with an embodiment.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic that has dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

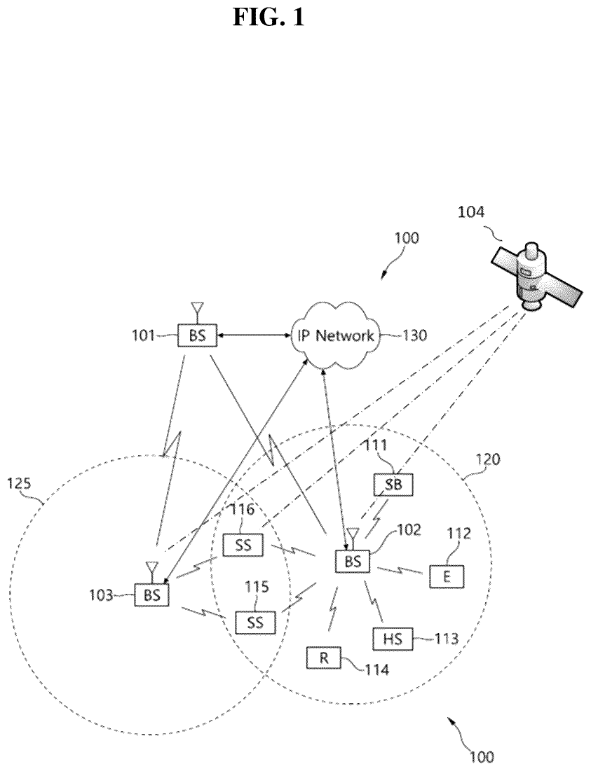

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with BSs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or103 can communicate directly with IP network 130 and provide UEs with direct wireless broadband access to the network 130. Further, gNB 101, 102, and/or 103 can provide access to other or additional external networks, such as external telephone networks or other types of data networks.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. The BSs 102 and 103 can also be on board the communication satellite(s) 104. One or more of the UEs (e.g., as depicted by UE 116) may be capable of at least some direct communication and/or localization with the communication satellite(s) 104.

A non-terrestrial network (NTN) refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof for supporting mobility in wireless networks. In certain embodiments, one or more of the BSs 101-103 include circuitry, programing, or a combination thereof to mobility in wireless networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the BS 101, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

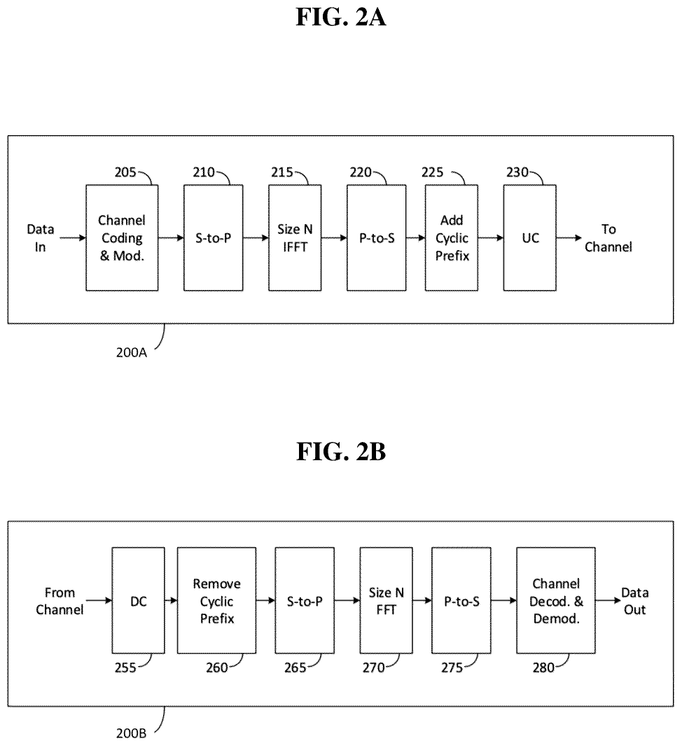

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible. In some embodiments, the transmit path 200A and the receive path 200B is configured to support mobility in wireless networks as described in various embodiments of the present disclosure.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory(ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

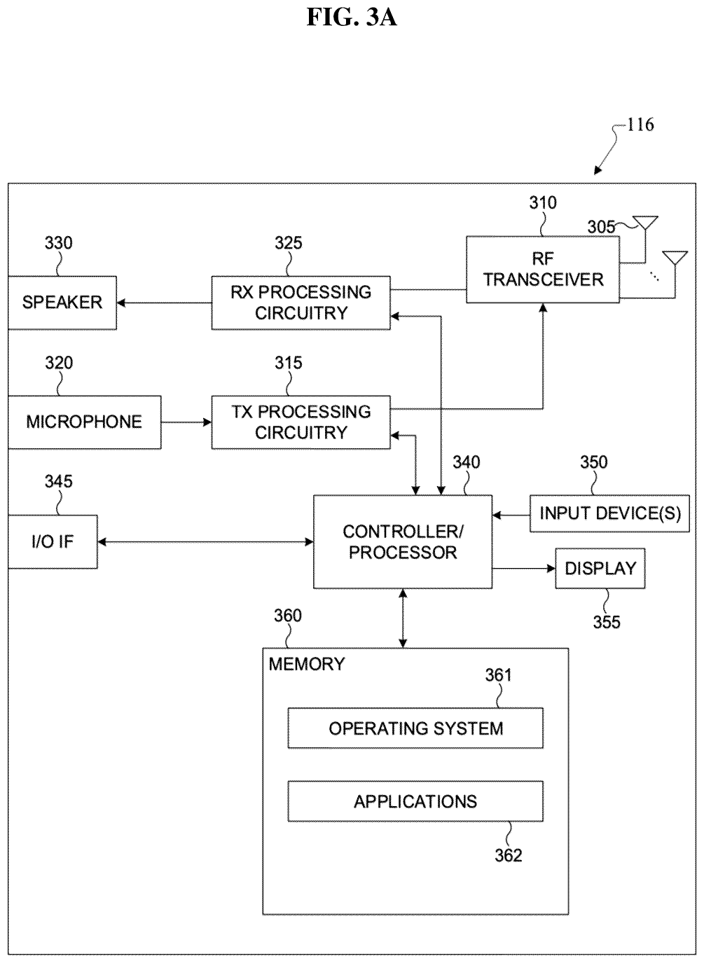

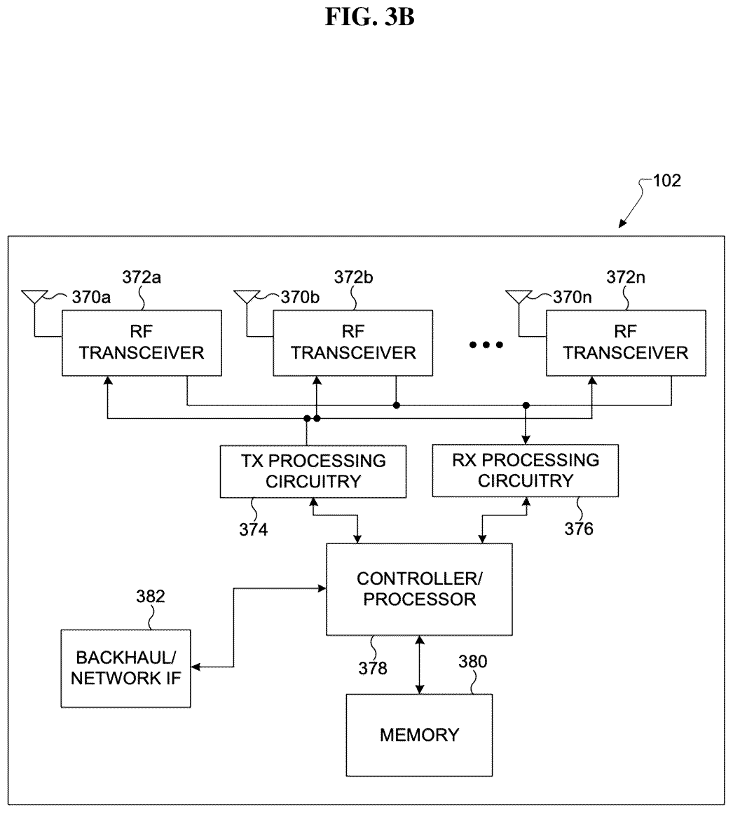

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 is coupled to the processor 340, directly or through intervening elements. The main processor 340 is also capable of executing other processes and programs resident in the memory 360 as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. For example, the main processor 340 may execute processes to support mobility in wireless networks as described in various embodiments of the present disclosure. The main processor 340 is also coupled to the I/O interface 345, which provides the UE 300A with the ability to connect to other devices such as laptop computers and handheld computers. The I/O interface 345 is the communication path between these accessories and the main processor 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. As another example, the processor 378 could support mobility in wireless networks. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting other processes in wireless communication systems as described in embodiments of the present disclosure. In some embodiments, the controller/processor 378 supports communications between entities, such as web real-time communication (web RTC). The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning the uplink transmission to a certain frequency and establishing the downlink transmission using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one TX processing circuitry 374 or RX processing circuitry 376 per RF transceiver).

As an example, Release13 of the LTE standard supports up to 16 CSI-RS [channel status information—reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel.14 LTE. For 5G and the next generation cellular systems such as 6G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms may be formulated by the inventors and designed to assist in providing an efficient description of the unique features within the disclosure. A list of both common and unique acronyms follows.

The following documents are hereby incorporated by reference in their entirety into the present disclosure as if fully set forth herein: i) 3GPP TS 38.300 v18,1.0; ii) 3GPP TS 38.331 v18.1.0; and iii) 3GPP TS 38.321 v18.1.0.

In the following discussion, the term “cell switch” can be replaced by other equivalent terminologies, e.g., handover (HO), mobility, cell change, etc. The conditional handover (CHO) procedure may mitigate connection interruption during a handover procedure of a UE. In CHO, a serving gNB (also referred to as a source gNB or a serving cell) of a UE may configure the UE with configuration(s) of CHO candidate cell(s) and execution conditions(s). An execution condition may include one or more triggering condition(s) that the UE may evaluate to determine whether the UE will execute a handover procedure to switch from the serving cell to one of the CHO candidate cells. The UE may release the stored configurations of CHO candidate cells after successful completion of the handover procedure. Frequent cell switching in high UE mobility scenarios or in NTN deployment scenarios may involve a serving gNB reconfiguring the UE with configuration(s) of CHO candidate cell(s) and execution conditions(s) after each handover. This procedure introduces latency, signaling overhead and interruption time.

To reduce signaling and delay for successive cell switching, the UE may rely on the LTM mechanism. LTM is a procedure in which a gNB receives L1 measurement report(s) from a UE, and based on the report(s) the gNB may change the UE serving cell by a cell switch command signalled via a medium access control-control element (MAC CE). The cell switch command indicates an LTM candidate configuration that the gNB previously prepared and provided to the UE through RRC signalling. Then the UE switches to the target configuration according to the cell switch command. However, in LTM, because the gNB determines whether the UE switches to a LTM candidate cell, handover latency may become a bottleneck in scenarios involving frequency cell switching.

Disclosed is a mechanism to combine components of LTM and CHO procedures, for instance, early timing advance (TA) acquisition and L1/L2 execution events based on L1 measurements, into an enhanced cell switch mechanism, which is referred to as successive conditional cell switch or successive cell switch.

The disclosure first presents the principles of the CHO and LTM procedures, followed by a discussion of the mechanism of the successive conditional cell switch procedure to show the advantages over the CHO or LTM.

In CHO, the source gNB may configure the UE with CHO configuration that contains the configuration of CHO candidate cell(s) generated by the candidate gNB(s) and execution condition(s) generated by the source gNB. An execution condition may include one or two trigger condition(s). CHO may support only single reference signal (RS) type and at most two different trigger quantities (e.g. reference signal received power (RSRP) and reference signal received quality (RSRQ), RSRP and signal to interference plus noise ratio (SINR), etc.) may be configured simultaneously for the evaluation of CHO execution condition of a single candidate cell. Before any CHO execution condition is satisfied, when the UE receives a HO command (without CHO configuration), the UE may execute the HO procedure regardless of any previously received CHO configuration. While executing the CHO procedure, i.e. from the time when the UE starts synchronization with the target cell, the UE may not monitor the source cell.

As in intra-NR radio access network (RAN) handover, in intra-NR RAN CHO, the preparation and execution phase of the conditional handover procedure is performed without involvement of the 5G core network (e.g., preparation messages are directly exchanged between gNBs). The release of the resources at the source gNB during the conditional handover completion phase is triggered by the target gNB.

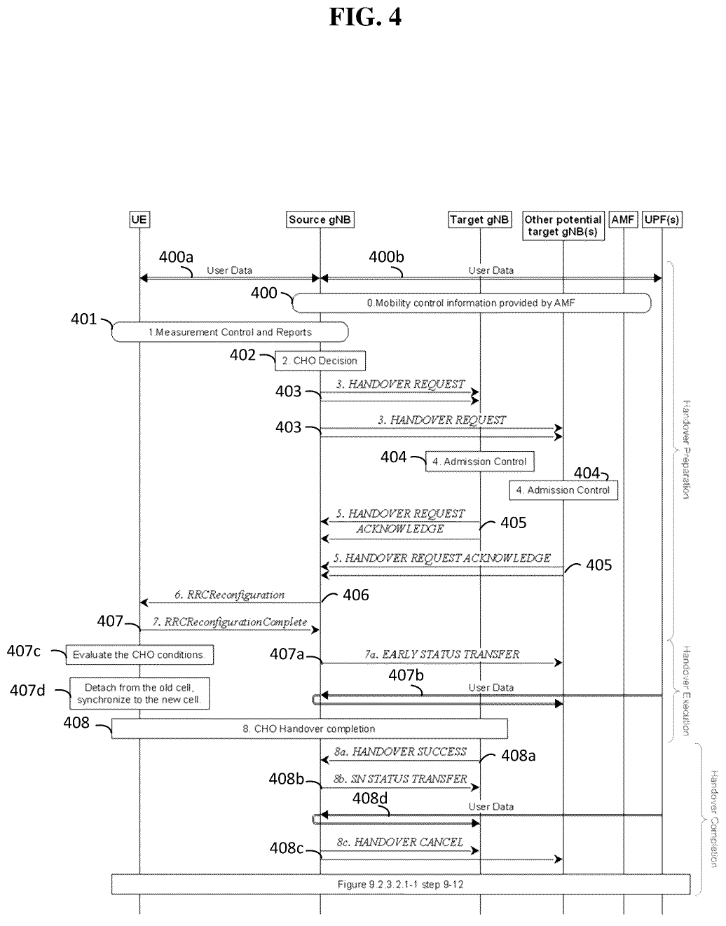

FIG. 4 shows the signalling diagram for the basic CHO scenario where neither the access and mobility management function (AMF) nor the user plane function (UPF) changes.

A UE in connected mode may exchange user data with a source gNB, as shown in operation 400a. The source gNB may forward the user data to one or more UPF(s), as shown in operation 400b.

In operation 400, the AMF provides mobility control information to the source gNB. The mobility control information may include UE context information regarding roaming and access restrictions which were provided either at connection establishment or at the last tracking area update.

In operation 401, the source gNB configures the UE measurement procedures and the UE reports according to the measurement procedure configuration.

In operation 402, the source gNb decides to use CHO.

In operation 403, the source gNb requests CHO for one or more candidate cells belonging to one or more candidate gNBs. The source gNB may send a CHO request message (HO REQUEST) for each candidate cell.

In operation 404, a target gNB (one of the candidate gNBs) performs an admission control function. The target gNB may perform slice-aware admission control if the source gNB sends the slice information to the target gNB. If the packet data unit (PDU) sessions are associated with non-supported slices the target gNB may reject such PDU Sessions.

In operation 405, the candidate gNB(s) sends CHO response (HO REQUEST ACKNOWLEDGE) including configuration of CHO candidate cell(s) to the source gNB. The candidate gNB(s) may send the CHO response message for each candidate cell.

In operation 406, the source gNB sends an RRCReconfiguration message to the UE, containing the configuration of CHO candidate cell(s) and CHO execution condition(s). The source gNB may send other reconfiguration message following the CHO configuration of candidate cells. The configuration of a candidate cell may not contain a dual active protocol stack (DAPS) handover configuration where the UE maintains connection with both the source gNB and the candidate cell simultaneously.

In operation 407, the UE sends an RRCReconfigurationComplete message to the source gNB. Operations 400a, 400b, and 400-407 may be collectively referred to as the handover preparation stage.

In operation 407a, if early data forwarding is applied, the source gNB sends the EARLY STATUS TRANSFER to the candidate gNBs. The UPF(s) may relay user data received from the source gNB (see operation 400b) to the candidate gNBs for early data forwarding., as shown in operation 407b.

In operation 407c, the UE maintains connection with the source gNB after receiving CHO configuration of candidate cell(s) and starts evaluating the CHO execution conditions for the candidate cell(s). If at least one CHO candidate cell satisfies the corresponding CHO execution condition, in operation 407d the UE detaches from the source gNB, applies the stored corresponding configuration for that selected candidate cell (target cell of the target gNB), and synchronizes to that candidate cell.

In operation 408, the UE completes the RRC handover procedure by sending RRCReconfigurationComplete message to the target gNB. The UE releases stored CHO configurations of candidate cell(s) after successful completion of RRC handover procedure. Operations 407a, 407b, 407c, 407d, and 408 may be collectively referred to as the handover execution stage

In operation 408a, the target gNB sends the HANDOVER SUCCESS message to the source gNB to inform the source gNB that the UE has successfully accessed the target cell.

In operation 408b, in response to the HANDOVER SUCCESS message, the source gNB sends the SN STATUS TRANSFER message to the target gNB. The UPF(s) may initiate late data forwarding to the target gNB as soon as the source gNB receives the HANDOVER SUCCESS message, as shown in operation 408d.

In operation 408c, the source gNB sends the HANDOVER CANCEL message toward the other signalling connections or other candidate target gNBs, if any, to cancel CHO for the UE. Operations 408a, 408b, 408c, 408d may be collectively referred to as the handover completion stage.

In CHO procedure, upon receiving CHO configuration in RRCReconfiguration message that contains configuration for multiple candidate cells, the UE starts evaluating the CHO execution conditions for the candidate cell(s). As mentioned, if at least one CHO candidate cell satisfies the corresponding CHO execution condition, the UE detaches from the source cell, applies configuration and synchronizes to the target cell, and completes the CHO procedure by sending RRC reconfiguration complete message to the target gNB. The UE releases stored CHO configurations after successful completion of handover procedure.

For mobility in connected mode, the network initiates the handover via higher layer signaling, e.g. RRC message, based on L3 (Layer 3) measurements. However, this procedure involves more latency, signaling overhead and interruption time that may become the key issue in some scenarios with frequent handover, e.g. UE in high-speed vehicular and in FR2 deployment scenarios. Reduction of overhead, latency and/or interruption time in handover procedure becomes a key consideration in these scenarios. A solution is the LTM, by which handover may be triggered by L1/L2 signaling based on L1 measurement. More specifically, LTM refers to a mobility mechanism for a UE to switch from the source cell to a target cell where the beam and cell switching is triggered by L1/L2 signaling, for example making beam and switching decisions based on L1 measurement on beams among neighboring cells.

LTM is a procedure in which a gNB receives L1 measurement report(s) from a UE, and on the basis of the L1 measurement report(s), the gNB may change UE serving cell by a cell switch command signalled via a MAC CE. The cell switch command indicates an LTM candidate configuration that the gNB previously prepared and provided to the UE through RRC signalling. Then the UE switches to the target configuration according to the cell switch command. The LTM procedure can be used to reduce the mobility latency.

The gNB may configure the UE to activate TCI states of one or multiple cells that are different from the current serving cell. For instance, the gNB may activate the TCI states of the LTM candidate cells in advance before any of those cells become the serving cell. This allows the UE to perform DL synchronization with those cells, thereby facilitating a faster cell switch to one of those cells when cell switch is triggered. All the activated TCI states except those received in the cell switch command may be deactivated upon LTM cell switch execution.

The gNB may configure the UE to initiate UL timing advance (TA) acquisition (called early TA) procedure of one or multiple candidate cells that are different from the current serving cells. If the candidate cell has the same N_{TA} as the current serving cells or N_{TA}=0, early TA acquisition procedure may not be initiated. The gNB may request the UE to perform early TA acquisition of a candidate cell before a cell switch. The early TA acquisition procedure may be triggered by PDCCH order or realized through UE-based TA measurement as configured by RRC. When early TA acquisition is triggered by PDCCH, the gNB/gNB-DU (distributed unit) to which the candidate cell belongs may calculate the TA value and may send it to the gNB/gNB-DU to which the serving cell belongs via gNB-CU (centralized unit). The serving cell may send the TA value in the LTM cell switch command MAC CE when triggering LTM cell switch. When early TA acquisition is realized through UE-based TA measurement, the UE may perform TA measurement for the candidate cells after being configured by RRC but the exact time the UE performs TA measurement is up to UE implementation. The UE may apply the UE-measured TA value and may perform random access channel-less (RACH-less) LTM upon receiving the cell switch command, if the cell switch command does not include any valid TA value. The gNB may also send a TA value in the LTM cell switch command MAC CE without early TA acquisition.

Depending on the availability of a valid TA value, the UE may perform either a RACH-less LTM or a RACH-based LTM cell switch. If the gNB provides the valid TA value in the cell switch command, the UE may apply the TA value as instructed by the gNB. In the case where UE-based TA measurement is configured, but no valid TA value is provided in the cell switch command, the UE may apply the valid TA value by itself if available. The UE may perform RACH-less LTM cell switch upon receiving the cell switch command whenever a valid TA value is available. If no valid TA value is available, the UE may perform RACH-based LTM cell switch.

Regardless of whether the gNB configures the UE for UE-based TA measurement for a certain candidate cell, the UE may still follow the PDCCH order, which includes performing a random access procedure towards one or more candidate cells. This also applies to the candidate cells for which the UE is capable of deriving TA values by itself. Additionally, regardless of whether the UE has already performed a random access procedure towards the candidate cells, it may still follow the UE-based TA measurement configuration if configured by the gNB.

For RACH-less LTM, the UE may access the target cell using either a configured grant or a dynamic grant. The gNB may provide the configured grant in the LTM candidate configuration, and the UE may select the configured grant occasion associated with the beam indicated in the cell switch command. Upon initiation of LTM cell switch to the target cell, the UE may start to monitor PDCCH on the target cell for dynamic scheduling. Before RACH-less LTM procedure completion, the UE does not trigger random access procedure if it does not have a valid physical uplink control channel (PUCCH) resource for triggered scheduling requests (SRs).

LTM may maintain security keys upon an LTM cell switch. The LTM procedure supports subsequent (also referred to as successive) LTM cell switch. LTM may support different base station architectures. For example, LTM supports both intra-gNB-DU and inter-gNB-DU mobility within the same gNB-CU; LTM supports both intra-frequency and inter-frequency mobility, including mobility to inter-frequency cell that is not a current serving cell; LTM supports primary cell (PCell) change in non-carrier aggregation (non-CA) scenario and non-dual connectivity (non-DC) scenario; LTM supports PCell and secondary cell(s) (SCell(s)) change in CA scenario; LTM supports PCell and master cell group (MCG) SCell(s) change in DC scenario; LTM supports intra-secondary node (intra-SN) secondary cell group (SCG) primary cell (PSCell) and SCG SCell(s) change without master node (MN) involvement in DC scenario. However, LTM does not support simultaneous PCell and PSCell change, nor does LTM support unlicensed spectrum.

Even though the UE stores the LTM candidate configurations, the UE may also execute any L3 handover except for DAPS handover. The gNB may send an RRC message containing configuration of the target cell for the UE to apply for any L3 handover (except DAPS). In the RRC message the target cell may add, modify, or release LTM candidate configurations.

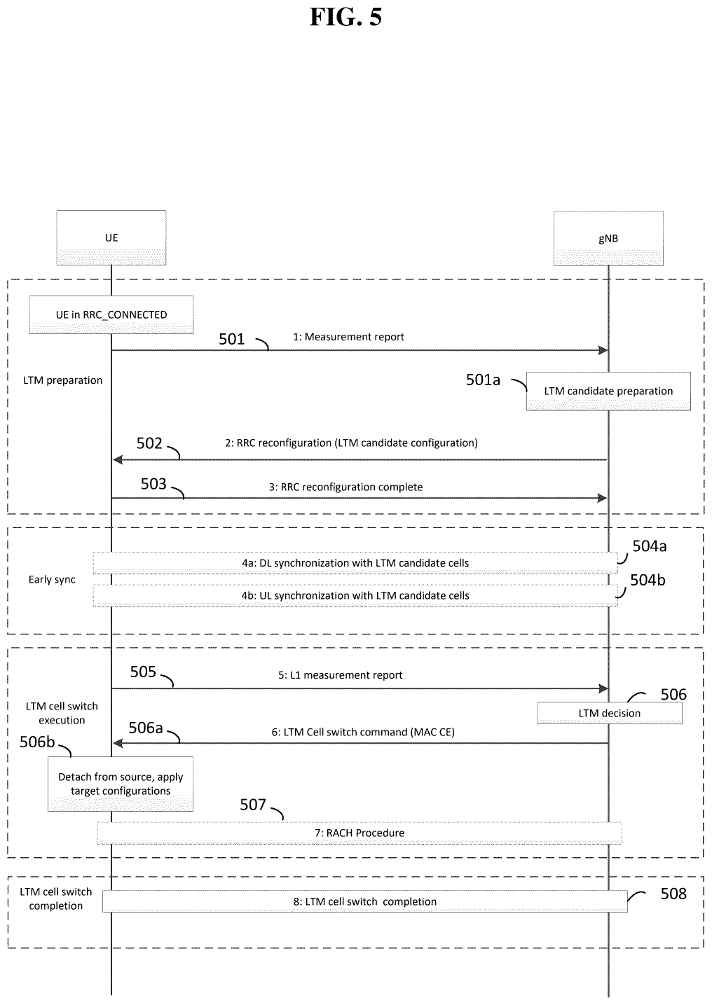

FIG. 5 shows the signalling diagram between a UE and a source gNB for the LTM procedure. The UE is in the RRC_connected mode with the source gNB. The general procedure depicted in FIG. 5 is also applicable to SCG LTM.

In operation 501, the UE sends a MeasurementReport message to the gNB. The gNB decides to configure LTM and initiates preparation of the LTM candidate configurations for LTM candidate cell(s), as shown in operation 501a.

In operation 502, the gNB transmits an RRCReconfiguration message to the UE. The RRCReconfiguration message includes the LTM candidate configurations.

In operation 503, the UE stores the LTM candidate configurations and transmits an RRCReconfigurationComplete message to the gNB. Operations 501, 501a, 502, and 503 may be collectively referred to as the LTM preparation stage.

In operation 504a, the UE may optionally perform DL synchronization with the LTM candidate cell(s) before receiving the cell switch command. The UE may activate and deactivate TCI states of LTM candidate cell(s), as triggered by the gNB.

In operation 504b, the UE may optionally perform UL synchronization with LTM candidate cell(s) before receiving the cell switch command, by using UE-based TA measurement, if configured, and/or by transmitting a preamble towards the candidate cell, as triggered by the gNB. When UE-based TA measurement is configured, the UE acquires the TA value(s) of the candidate cell(s) by measurement. The UE may perform early TA acquisition with the candidate cell(s) as requested by the gNB before receiving the cell switch command. The gNB may issue a PDCCH to trigger CFRA, following which the UE may send preamble towards the indicated candidate cell. In order to minimize the data interruption of the source cell due to CFRA towards the candidate cell(s), the UE may not receive random access response from the network for the purpose of TA value acquisition and the TA value of the candidate cell may be indicated in the cell switch command. The UE does not maintain the TA timer for the candidate cell and relies on network implementation to guarantee the TA validity. Operations 504a and 504b may be collectively referred to as the LTM early synchronization stage.

In operation 505, the UE performs L1 measurements on the configured LTM candidate cell(s) and transmits L1 measurement reports to the gNB. The UE may perform L1 measurement as long as RRC reconfiguration (operation 502) is applicable.

In operation 506, the gNB decides to execute cell switch to a target cell.

In operation 506a, the gNB transmits to the UE an LTM cell switch command MAC CE for triggering cell switch by including a target configuration ID which indicates the index of the candidate configuration of the target cell, a beam indicated with a TCI state or beams indicated with DL and UL TCI states, and a timing advance command for the target cell, if available.

In operation 506b, the UE switches to the target cell and applies the candidate configuration indicated by the target configuration ID.

In operation 507, the UE may optionally perform the random access procedure towards the target cell, if UE does not have valid TA of the target cell as specified in clause 5.18.35 of 3GPP TS 38.321 specification. Operations 505, 506, 506a, 506b, and 507 may be collectively referred to as the LTM cell switch execution stage.

In operation 508, the UE completes the LTM cell switch procedure by sending RRCReconfigurationComplete message to target cell. If the UE has performed a RA procedure in operation 507, the UE considers that LTM cell switch execution is successfully completed when the random access procedure is successfully completed. For RACH-less LTM, the UE considers that LTM cell switch execution is successfully completed when the UE determines that the network has successfully received its first UL data. Operation 508 may be referred to as the LTM cell switch completion stage.

The UE may perform subsequent LTM by repeating operations of the early synchronization stage, the LTM cell switch execution stage, and the LTM cell switch completion stage without releasing other LTM candidate configurations after each LTM cell switch completion. For example, the UE may perform operations 504a and 504b of the early synchronization stage, operations 505, 506, 506a, 506b, and 507 of the LTM cell switch execution stage, and operation 508 of the LTM cell switch completion stage multiple times for subsequent LTM cell switch executions using the LTM candidate configuration(s) provided in operation 502.

As mentioned, the signaling operations described in FIG. 5 is applicable to both intra-gNB-DU LTM and inter-gNB-DU LTM within the same gNB-CU.

After receiving an LTM cell switch command MAC CE, the UE performs MAC reset. The gNB may control through RRC signaling whether the UE performs RLC re-establishment and packet data convergence protocol (PDCP) data recovery during cell switch.

Considering the advantage of CHO for improving HO reliability by triggering HO with pre-configured conditions and the advantage of LTM for reducing HO latency by triggering HO with L1/L2 signaling, it is beneficial to improve HO performance by combining components of LTM and CHO procedures into an advanced cell switch mechanism, which is referred to conditional LTM (CLTM).

CLTM may refer to an LTM procedure where the UE evaluates execution condition(s) for one or multiple candidate cells based on L1 measurements and where the UE autonomously executes a cell switch to a candidate cell only when the corresponding execution condition is met. CLTM may support subsequent LTM to reduce signaling and delay for successive cell switch. In one aspect, the UE may perform successive CLTM/CHO without CLTM/CHO configuration release or reconfiguration between CLTM/CHO executions. Disclosed is an improved cell switch mechanism, referred to as successive conditional cell switch or successive cell switch, which may also referred to as subsequent conditional cell switch or subsequent cell switch. While the procedure for successive cell switch is applicable to TN and/or NTN fast mobility scenarios, the disclosed mechanism is not limited to successive CLTM and/or successive CHO.

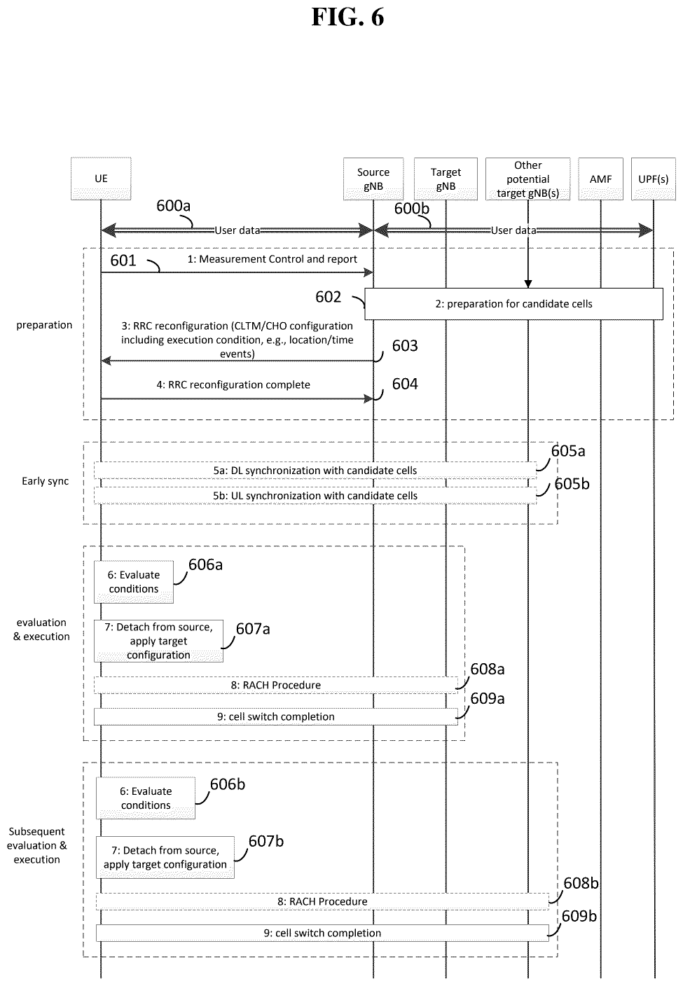

FIG. 6 shows the signalling diagram for successive conditional cell switching in accordance with an embodiment.

A UE in connected mode may exchange user data with a source gNB, as shown in operation 600a. The source gNB may forward the user data to one or more UPF(s), as shown in operation 600b

In operation 601, the source gNB configures the UE measurement procedures and the UE reports according to the measurement configuration. In one embodiment, the measurement configuration contains the configuration of L1/L3 measurements and L1/L3 measurement reports.

In operation 602, the source gNB communicates with one or multiple potential target gNBs, and/or AMF, and/or UPF to prepare successive cell switch configuration (e.g., for successive CLTM/CHO).

In one embodiment, the source gNB requests cell switch configurations for one or more candidate cells belonging to one or more candidate gNBs. In one embodiment, the source gNB sends a message (e.g., Handover Request message) for each candidate cell or for each candidate gNB, which may include necessary information to prepare the configuration at the candidate cell/gNB. The information may include the target cell ID, KgNB*, the cell radio network temporary identifier (C-RNTI) of the UE in the source gNB, radio resource management configuration (RRM-configuration) including UE inactive time, basic access stratum configuration (AS-configuration) including antenna information and DL carrier frequency, the current quality of service (QoS) flow to data radio bearer (DRB) mapping rules applied to the UE, the system information block 1 (SIB1) information from the source gNB, the UE capabilities for different radio access technologies (RATs), PDU session related information, and UE reported measurement information including beam-related information if available. The PDU session related information may include the slice information and QoS flow level QoS profile(s). Each candidate gNB prepares the configuration for cell switch with L1/L2 and sends one or multiple responses (e.g., Handover Request Acknowledge message) to the source gNB. The response from a candidate gNB may include the configuration of candidate cell(s) to the source gNB.

In operation 603, the source gNB transmits an RRCReconfiguration message to the UE including the successive cell switch configuration. The successive cell switch configuration may include a list of candidate cells. For each candidate cell, the successive cell switch configuration may include the execution/trigger condition, which may be associated with at least one of a location event and/or a time event and/or L3 RRM measurement event(s) and/or L1 measurement event(s). The RRCReconfiguration message may also include updated information for the successive cell switch configuration.

In one embodiment of the successive cell switch configuration, the candidate cell configuration may include an execution condition for each candidate cell.

In one embodiment, an execution condition may include 1 or 2 or more measurement IDs. Each measurement ID may be associated with a measurement resource ID and an event ID, which refers to a measurement resource (e.g., CSI resource) and a conditional event, respectively. The measurement resource is configured for the measurement of the candidate cell. A measurement resource may refer to one or multiple synchronization signal blocks (SSBs) (each can be identified by an SSB index), and/or one or multiple CSI-RSs (each can be identified by a CSI-RS resource ID).

In one embodiment, an execution condition may be associated with 1 or 2 or more measurement report configurations (e.g., CSI report configurations). Each measurement report configuration may be identified by a measurement report configuration ID, and may include a measurement resource (identified by a measurement resource ID), and/or a measurement report type. A measurement resource may include one or multiple SSBs (each may be identified by an SSB index), and/or one or multiple CSI-RSs (each may be identified by a CSI-RS resource ID). The measurement report type may be event-triggered, and associated with a conditional event.

In one embodiment, for a measurement resource referring to one or multiple CSI-RSs, the network (e.g., gNB) may configure/provide one or more of the following parameters for each CSI-RS resource:
The candidate cell ID for which the CSI-RS resource is provided.
CSI-RS resource index associated with the CSI-RS resource to be measured (and/or used for CSI reporting).
Subcarrier spacing of CSI-RS. The following values are applicable depending on the used frequency: 15, 30, or 60 kHz for FR1; 60 or 120 kHz for FR2-1; 120, 480, or 960 kHz for FR2-2.
Reference Serving Cell Index. It indicates the serving cell providing the timing reference for CSI-RS resources without an associated SSB. The field may be present only if there is at least one CSI-RS resource configured without an associated SSB. If this field is absent, the UE may use the timing of the PCell for measurements on the CSI-RS resources without an associated SSB. The CSI-RS resources and the serving cell indicated by Reference Serving Cell Index (refServCellIndex) for timing reference are located in the same band.
Frequency domain density for the 1-port CSI-RS
Number of physical resource blocks (PRBs) that indicates the allowed size of the measurement BW in PRBs
Starting PRB index of the measurement bandwidth.
Associated SSB index. This indicates that UE bases the timing of this CSI-RS resource on the timing of the candidate cell identified by the indicated candidate cell ID. In this case, the UE is not required to monitor that CSI-RS resource if the UE cannot detect the SS/PBCH block indicated by this associated SSB index and the indicated candidate cell ID. If this information is absent, the UE may base the timing of this CSI-RS resource on the timing of the serving cell indicated by Reference Serving Cell Index. In this case, the UE measures the CSI-RS resource even if the UE cannot detect the SS/PBCH block(s) indicated by the associated SSB index.
Time domain allocation within a physical resource block. This parameter may indicate the first OFDM symbol in the PRB used for CSI-RS.
Frequency domain allocation within a PRB.
Flag of quasi-colocation indicates that the CSI-RS resource is quasi co-located with the associated SS/PBCH block.
Information on sequence generation, e.g., scrambling ID for CSI-RS.
Information on slot that indicates the CSI-RS periodicity (in milliseconds) and for each periodicity the offset (in number of slots). When subcarrierSpacing is set to kHz15, the maximum offset values for periodicities ms4/ms5/ms10/ms20/ms40 are 3/4/9/19/39 slots. When subcarrierSpacing is set to kHz30, the maximum offset values for periodicities ms4/ms5/ms10/ms20/ms40 are 7/9/19/39/79 slots. When subcarrierSpacing is set to kHz60, the maximum offset values for periodicities ms4/ms5/ms10/ms20/ms40 are 15/19/39/79/159 slots. When subcarrierSpacing is set kHz120, the maximum offset values for periodicities ms4/ms5/ms10/ms20/ms40 are 31/39/79/159/319 slots. When subcarrierSpacing is set to kHz480, the maximum offset values for periodicities ms4/ms5/ms10/ms20/ms40 are 127/159/319/639/1279 slots. When subcarrierSpacing is set to kHz960, the maximum offset values for periodicities ms4/ms5/ms10/ms20/ms40 are 255/319/639/1279/2559 slots. If slotConfig-r17 is present, the UE may ignore the slotConfig (without suffix).

In one embodiment, a conditional event may refer to a L3 RRM measurement event, and/or a L1 beam measurement event, and/or location/time event. The L3 RRM measurement events may include at least one of the following events:
condEvent A3: the L3 RRM measurement of the given candidate cell becomes better than that of the PCell/PSCell by an amount of offset;
condEvent A4: the L3 RRM measurement of the given candidate cell becomes better than an absolute threshold;
condEvent A5: the L3 RRM measurement of the PCell/PSCell becomes worse than an absolute threshold1 AND the L3 RRM measurement of the given candidate cell becomes better than another absolute threshold2.

In one embodiment, the location/time events may include at least one of the following events:
condEvent D1: distance between the UE and a reference location, referenceLocation1, of the serving cell becomes larger than a first configured distance threshold, distance ThreshFromReference1, AND distance between the UE and a reference location, referenceLocation2, of the given candidate cell becomes shorter than a second configured distance threshold, distanceThreshFromReference2;
condEvent D2: distance between the UE and the serving cell moving reference location, which is determined based on parameter movingReferenceLocation and its corresponding satellite ephemeris and epoch time broadcast in system information, becomes larger than a first configured distance threshold, distance ThreshFromReference1, AND distance between the UE and a moving reference location determined based on parameter referenceLocation and its corresponding satellite ephemeris and epoch time for the given candidate cell becomes shorter than a second configured distance threshold, distanceThreshFromReference2;
condEvent T1: time measured at the UE becomes more than a configured time threshold, t1-Threshold, but is less than t1-Threshold+duration.
condEvent D1T1: distance between the UE and a reference location of the given candidate cell becomes shorter than a configured distance threshold AND time measured at the UE becomes more than a configured time threshold t1-Threshold but is less than t1-Threshold+duration.
condEvent D2T1: distance between the UE and a moving reference location determined based on parameter referenceLocation and its corresponding satellite ephemeris and epoch time for the given candidate cell becomes shorter than a configured threshold distance AND time measured at the UE becomes more than a configured time threshold t1-Threshold but is less than t1-Threshold+duration.
condEvent D3: distance between the UE and a reference location of the given candidate cell becomes shorter than a configured threshold distance.
condEvent D4: distance between the UE and a moving reference location determined based on parameter referenceLocation and its corresponding satellite ephemeris and epoch time for the given candidate cell becomes shorter than a configured threshold distance.

In one embodiment, for condEventD1T1, the UE considers the entering condition for this event to be satisfied when both condition D1T1-1 and condition D1T1-2, as specified below, are fulfilled; the UE considers the exit condition for this event to be satisfied when condition D1T1-3 or condition D1T1-4, i.e. at least one of the two conditions, as specified below, are fulfilled:

Inequality D1T1-1 (Entering condition 1)

$$Ml + Hys < ThreshD ;$$

Inequality D1T1-2 (Entering condition 2)

$$Mt < ThreshT ;$$

Inequality D1T1-3 (Exit condition 1)

$$Ml - Hys > ThreshD ;$$

Inequality D1T1-4 (Exit condition 2)

$$Mt > ThreshT + Duration ;$$

where the variables in the formulas are defined as follows:
Ml is the distance between the UE and a reference location for this event not taking into account any offsets, expressed in meters;
Hys is the hysteresis parameter for this event, expressed in the same unit as Ml;
ThreshD is the distance threshold for this event defined as a distance from a reference location, expressed in the same unit as Ml;
Mt is the time measured at UE, expressed in millisecond ms;
ThreshT is the time threshold parameter for this event, expressed in the same unit as Mt;
Duration is the duration parameter for this event, expressed in the same unit as Mt.

In one embodiment, for condEventD2T1, the UE considers the entering condition for this event to be satisfied when both condition D2T1-1 and condition D2T1-2, as specified below, are fulfilled; the UE considers the exit condition for this event to be satisfied when condition D2T1-3 or condition D2T1-4, i.e. at least one of the two conditions, as specified below, are fulfilled:

Inequality D2T1-1 (Entering condition 1)

$$Ml + Hys < ThreshD ;$$

Inequality D2T1-2 (Entering condition 2)

$$Mt < ThreshT ;$$

Inequality D2T1-3 (Exit condition 1)

$$Ml - Hys > ThreshD ;$$

Inequality D2T1-4 (Exit condition 2)

$$Mt > ThreshT + Duration ;$$

where the variables in the formulas are defined as follows:
Ml is the distance between the UE and a moving reference location for this event not taking into account any offsets, expressed in meters. The moving reference location is determined based on a reference location at a corresponding reference time and the satellite ephemeris for the cell associated to the reference location;
Hys is the hysteresis parameter for this event, expressed in the same unit as Ml;
ThreshD is the distance threshold for this event defined as a distance from a reference location, expressed in the same unit as Ml;
Mt is the time measured at UE, expressed in millisecond ms;
ThreshT is the time threshold parameter for this event, expressed in the same unit as Mt;
Duration is the duration parameter for this event, expressed in the same unit as Mt.

In one embodiment, for condEventD3, the UE considers the entering condition for this event to be satisfied when condition D3-1, as specified below, is fulfilled; the UE considers the exit condition for this event to be satisfied when condition D3-2 as specified below, is fulfilled:

Inequality D3-1 Enterin condition 1)

$$Ml + Hys < ThreshD ;$$

Inequality D3-2 (Exit condition 1)

$$Ml - Hys > ThreshD ;$$

where the variables in the formulas are defined as follows:
Ml is the distance between the UE and a reference location for this event not taking into account any offsets, expressed in meters.
Hys is the hysteresis parameter for this event, expressed in the same unit as Ml.
ThreshD is the distance threshold for this event defined as a distance from a reference location, expressed in the same unit as M.

In one embodiment, for condEventD4, the UE considers the entering condition for this event to be satisfied when condition D4-1, as specified below, is fulfilled; the UE considers the exit condition for this event to be satisfied when condition D4-2 as specified below, is fulfilled:

Inequality D4-1 (Entering condition 1)

$$Ml + Hys < ThreshD ;$$

Inequality D4-2 (Exit condition 1)

$$Ml - Hys > ThreshD ;$$

where the variables in the formulas are defined as follows:
Ml is the distance between the UE and a moving reference location for this event not taking into account any offsets, expressed in meters. The moving reference location is determined based on a reference location at a corresponding reference time and the satellite ephemeris for the cell associated to the reference location;
Hys is the hysteresis parameter for this event, expressed in the same unit as Ml;
ThreshD is the distance threshold for this event defined as a distance from a reference location, expressed in the same unit as M.

In one embodiment, the execution condition for a candidate cell is associated with only one conditional event (e.g., by including only one measurement ID or measurement report configuration), where any one of the above L3 events, L1 events, and location/time events may be configured.

In one embodiment, the execution condition for a candidate cell is associated with two conditional events (e.g., by including two measurement IDs or two measurement report configurations). For example, a location event and a time event may be configured together, a location event and a L3 event may be configured together, a time event and a L3 event may be configured together, a location event and a L1 event may be configured together, a time event and a L1 event can be configured together, or a L3 event and a L1 event may be configured together.

In another embodiment of the successive cell switch configuration at operation 603, the configuration may include satellite assistance information for NTN. In one example, a list of satellite assistance information elements is provided with each satellite assistance information element identified by a satellite ID. A satellite assistance information element may include ephemeris information, and/or common TA information, and/or epoch time, and/or validity duration, and/or polarization information, and/or scheduling timing offset information. A candidate cell may be associated to a satellite ID and the UE may apply the corresponding assistance information for the candidate cell. A candidate cell (e.g., quasi-earth-fixed cell, earth-moving cell) may be associated with a reference location and/or reference time. In one embodiment, a candidate cell may be associated with a service stop time indicating the time when a cell provided via NTN is going to stop serving the area it is currently covering. If a service stop time is configured for a candidate cell, the UE may release the configuration and/or the stored information for the candidate cell if the measured time is after the service stop time.

In one embodiment, to provide the ephemeris information and/or common TA information of a satellite, multiple versions of ephemeris information and/or common TA information may be included, where each version is associated with a different validity time window. The UE may determine that the current time belongs to a certain validity time window and may apply the corresponding version of the ephemeris information and/or common TA information. The validity time window may be indicated by a start time and a duration. In one embodiment, the start time may be indicated by a system frame number (SFN) and/or a slot index and/or a symbol index with respective to a current serving cell. Alternatively, the start time may be indicated by an absolute time (e.g., UTC time and/or GNSS time), which may be with respect to the time at a reference point.

In one example of the satellite ephemeris information, if the configuration provides a reference configuration and the reference configuration includes satellite assistance information, a delta ephemeris information for a satellite may be provided with respect to the reference configuration. The delta ephemeris may be expressed either in format of position and velocity state vector in earth-centered earth-fixed (ECEF) frame or in format of orbital parameters in earth-centered inertial (ECI) frame. The position parameters (position X/Y/Z) and/or the velocity parameters (velocity X/Y/Z) and/or the orbital parameters (e.g., eccentricity, inclination, longitude of ascending node, mean anomaly, argument of periapsis, semi major axis) may be indicated by an integer value. The actual value to be applied equals a product of the indicated integer and a scalar multiplier, where the scalar multiplier is pre-defined. The UE may determine the ephemeris information of a satellite based on the delta ephemeris and the ephemeris included in the reference configuration.

In operation 604, the UE stores the successive cell switch configurations and transmits an RRCReconfigurationComplete message to the source gNB. Operations 601-604 may be collectively referred to as the successive cell switch preparation stage.

In operation 605a, the UE may optionally perform DL synchronization with the candidate cell(s) before cell switch execution. The UE may activate and deactivate TCI states of candidate cell(s), as triggered by the gNB.

In operation 605b, the UE may optionally perform UL synchronization with candidate cell(s) before cell switch execution, by using UE-based TA measurement, if configured, and/or by transmitting a preamble towards the candidate cell, as triggered by the gNB or initiated by the UE. In one embodiment, when UE-based TA measurement is configured, the UE acquires the TA value(s) of the candidate cell(s) by measurement. In one embodiment, the UE performs early TA acquisition via CFRA triggered by a PDCCH order from the source cell, following which the UE sends a preamble towards the indicated candidate cell. In another embodiment, the UE performs early TA acquisition by UE-initiated RACH towards the candidate cell. Operations 605a and 605b may be collectively referred to as the early synchronization stage.

In one embodiment of early synchronization at operation 605b, the UE may perform early UL synchronization based on the satellite assistance information for candidate cells. In one example, the UE may acquire TA of a candidate cell by deriving TA and/or frequency pre-compensation for a candidate cell based on the corresponding satellite assistance information. In a second example, the UE may acquire TA by performing a random access procedure towards a candidate cell if the measured time is within a configured time window (e.g., the aforementioned time event is fulfilled).

In operation 606a, the UE maintains connection with the source gNB after receiving the successive cell switch configuration and starts evaluating the execution conditions for the candidate cell(s).

In one embodiment of the execution condition evaluation at operation 606a for NTN, the UE may evaluate the candidate cells based on the satellite assistance information. In one example, if the configuration provides a reference location at a reference time for a candidate cell, the UE may derive the moving reference location of a candidate cell based on the associated satellite assistance information and/or the given reference location at a reference time. In another example, the UE may consider the candidate cell as an applicable cell (e.g., a potential target cell) and/or may start to evaluate any event if the measured time is before the service stop time if configured for the candidate cell.

As an example, if a time event is configured for a candidate cell, when the time event is fulfilled, the UE considers the candidate cell is an applicable cell and/or starts to evaluate the L3 measurement event, and/or the L1 measurement event, and/or the location event associated with the candidate cell. In another example, if a location event is configured for a candidate cell, when the location event is fulfilled, the UE considers the candidate cell is an applicable cell and/or starts to evaluate the L3 measurement event and/or the L1 measurement event associated with the candidate cell. In yet one more example, the UE evaluates the events based on priorities, where time events have the 1^{st} priority (i.e., first evaluated), location events have the 2^{nd} priority (second evaluated), and other events have lower priority.

In operation 607a, if at least one candidate cell satisfies the corresponding execution condition, the UE detaches from the source gNB, applies the stored corresponding configuration for that selected candidate cell, which is referred to as the target cell.

In operation 608a, the UE may optionally perform the random access procedure towards the target cell, if UE does not have valid TA of the target cell.

In operation 609a, the UE completes a cell switch procedure by sending RRCReconfigurationComplete message to the target cell. If the UE has performed a RA procedure in operation 608a, the UE considers that cell switch execution is successfully completed when the random access procedure is successfully completed. For RACH-less cell switch, the UE considers that the cell switch execution is successfully completed when the UE determines that the network has successfully received its first UL data. Operations 606a, 607a, 608a, and 609a may be collectively referred to as the evaluation and execution stage.

For successive cell switch (e.g., subsequent CLTM, CHO), the UE may repeat the operations of the early synchronization stage and the operation of the evaluation and execution stage without releasing the successive cell switch configuration after each cell switch completion. The UE may perform these operations multiple times for successive cell switch executions using the configuration provided in operation 603.

For example, in operation 606b, the UE evaluates the execution conditions for subsequent candidate cell(s). In operation 607b, if at least one subsequent candidate cell satisfies the corresponding execution condition, the UE detaches from the current source cell and applies the stored corresponding configuration for that selected subsequent candidate cell (e.g., a new target cell). In operation 608b, the UE may optionally perform the random access procedure towards the new target cell, if UE does not have valid TA of the new target cell. In operation 609b, he UE completes a cell switch procedure by sending RRCReconfigurationComplete message to the new target cell.

Iin one embodiment of the execution condition evaluation at operation 606b of a subsequent cell switch, the UE may consider a candidate cell to be an applicable cell when the candidate cell has a physical cell identity matching the value indicated in the measurement resource within the measurement configuration received in the successive cell switch configuration. For each event of the execution condition, if the event ID is associated with a L1 measurement event or a L3 measurement event or a location event or a time event for a subsequent cell switch (e.g., an aforementioned event), and if the entry condition applicable for this event is fulfilled for the applicable cell, the UE may consider the event associated with that entry condition to be fulfilled. If all event(s) associated with an execution condition for a candidate cell are fulfilled, the UE may consider the candidate cell associated with that execution condition as a triggered cell and may initiate the conditional cell switch execution. If more than one triggered cell exists, the UE may select one of the triggered cells as the selected cell for conditional cell switch execution. The UE may decide how to select one of the triggered cells as the selected cell, e.g. the UE considers beams and beam quality to select one of the triggered cells for execution. Otherwise (only one triggered cell exists), the UE may consider the triggered cell as the selected cell for conditional cell switch execution. For the selected cell(s) of conditional cell switch execution, the UE may apply the stored configuration of the selected cell(s) and may perform cell switch (e.g., LTM execution, CHO execution).

An example of successive cell switch configuration (e.g., successive CLTM) is given as follows:

LTM-Config-r18 ::= SEQUENCE {

| | |
|---|---|
| ltm-ReferenceConfiguration-r18 | SetupRelease {ReferenceConfiguration-r18} |

OPTIONAL, -- Need M

| | |
|---|---|
| ltm-CandidateToReleaseList-r18 | SEQUENCE (SIZE (1..maxNrofLTM-Configs-r18)) OF |

LTM-CandidateId-r18
OPTIONAL, -- Need N

| | |
|---|---|
| ltm-CandidateToAddModList-r18 | SEQUENCE (SIZE (1..maxNrofLTM-Configs-r18)) |

OF LTM-Candidate-r18
OPTIONAL, -- Need N

| | |
|---|---|
| ltm-ServingCellNoResetID-r18 | INTEGER (1..maxNrofLTM-Configs-plus1-r18) |

```
OPTIONAL, -- Need N
  ltm-CSI-ResourceConfigToAddModList-r18 SEQUENCE (SIZE (1..maxNrofLTM-CSI-
ResourceConfigurations-r18)) OF LTM-CSI-ResourceConfig-r18
OPTIONAL, -- Need N
  ltm-CSI-ResourceConfigToReleaseList-r18 SEQUENCE (SIZE (1..maxNrofLTM-CSI-
ResourceConfigurations-r18)) OF LTM-CSI-ResourceConfigId-r18
OPTIONAL, -- Need N
```

| | |
|---|---|
| attemptLTM-Switch-r18 | ENUMERATED {true} |

```
OPTIONAL, -- Cond LTM-MCG
  ltm-ServingCellUE-MeasuredTA-ID-r18 INTEGER (1..maxNrofLTM-Configs-plus1-r18)
OPTIONAL, -- Need N
    ...
    [[
  ltm-CSI-ResourceConfigToAddModListExt-r19 SEQUENCE (SIZE (1..maxNrofLTM-CSI-
ResourceConfigurations-r18)) OF LTM-CSI-ResourceConfig-r19
    ]]
}
```

| | |
|---|---|
| LTM-Candidate-r18 ::= | SEQUENCE { |

| | |
|---|---|
| ltm-CandidateId-r18 | LTM-CandidateId-r18, |
| ltm-CandidatePCI-r18 | PhysCellId |

OPTIONAL, -- Need M

| | |
|---|---|
| ltm-SSB-Config-r18 | LTM-SSB-Config-r18 |

OPTIONAL, -- Need M

| | |
|---|---|
| ltm-CandidateConfig-r18 | OCTET STRING (CONTAINING |

RRCReconfiguration)
OPTIONAL, -- Need M

| | |
|---|---|
| ltm-ConfigComplete-r18 | ENUMERATED {true} |

OPTIONAL, -- Need R

| | |
|---|---|
| ltm-EarlyUL-SyncConfig-r18 | OCTET STRING (CONTAINING EarlyUL- |

SyncConfig-r18)
OPTIONAL, -- Need R

| | |
|---|---|
| ltm-EarlyUL-SyncConfigSUL-r18 | OCTET STRING (CONTAINING EarlyUL- |

SyncConfig-r18)
OPTIONAL, -- Need R

| | |
|---|---|
| ltm-TCI-Info-r18 | LTM-TCI-Info-r18 |

OPTIONAL, Need M

| | |
|---|---|
| ltm-NoResetID-r18 | INTEGER (1..maxNrofLTM-Configs-plus1-r18) |

OPTIONAL, -- Need M

| | |
|---|---|
| ltm-UE-MeasuredTA-ID-r18 | INTEGER (1..maxNrofLTM-Configs-plus1-r18) |

```
OPTIONAL, -- Need M
    ...
    [[
```

| | |
|---|---|
| ltm-CSI-RS-Config-r19 | LTM-CSI-RS-Config-r19 |

OPTIONAL, -- Need M

| | |
|---|---|
| condExecutionCond-r19 | SEQUENCE (SIZE (1..2)) OF LTM-CSI-ReportConfigId- |

r18
OPTIONAL, -- Need M

| | |
|---|---|
| satelliteInfo-r19 | SEQUENCE (SIZE (1.. maxNrofSatellites-r19)) OF SatConfig-r19 |

OPTIONAL, -- Need M
]]
}

| | |
|---|---|
| LTM-CSI-ResourceConfig-r19 ::= | SEQUENCE { |
| ltm-CSI-ResourceConfigId-r18 | LTM-CSI-ResourceConfigId-r18, |
| ltm-CSI-RS-ResourceSet-r19 | LTM-CSI-RS-ResourceSet-r19, |

...
}

| | |
|---|---|
| LTM-CSI-RS-ResourceSet-r19 ::= | SEQUENCE { |

| | |
|---|---|
| subcarrierSpacing | SubcarrierSpacing, |
| csi-RS-CellList-LTM | SEQUENCE (SIZE (1..maxNrofCSI-RS-CellsLTM)) OF CSI- |

RS-Cell-LTM,

| | | |
|---|---|---|
| refServCellIndex | ServCellIndex | OPTIONAL |

-- Need S
}

| | |
|---|---|
| CSI-RS-Cell-LTM :: | SEQUENCE { |
| cellId | PhysCellId, |
| csi-rs-MeasurementBW | SEQUENCE { |
| nrofPRBs | ENUMERATED { size24, size48, size96, size192, size264}, |
| startPRB | INTEGER(0..2169) |

},

| | |
|---|---|
| density | ENUMERATED {d1,d3} |

OPTIONAL, -- Need R

| | |
|---|---|
| csi-rs-ResourceList-LTM | SEQUENCE (SIZE (1..maxNrofCSI-RS-ResourcesLTM)) OF |

CSI-RS-Resource-LTM
}

| | |
|---|---|
| CSI-RS-Resource-LTM ::= | SEQUENCE { |
| csi-RS-Index | CSI-RS-Index, |
| slotConfig | CHOICE { |
| ms4 | INTEGER (0..31), |
| ms5 | INTEGER (0..39), |
| ms10 | INTEGER (0..79), |
| ms20 | INTEGER (0..159), |
| ms40 | INTEGER (0..319) |

},

| | |
|---|---|
| associatedSSB | SEQUENCE { |
| ssb-Index | SSB-Index, |
| isQuasiColocated | BOOLEAN |

| | |
|---|---|
| } | OPTIONAL, -- Need R |

| | |
|---|---|
| frequencyDomainAllocation | CHOICE { |

| | |
|---|---|
| row1 | BIT STRING (SIZE (4)), |
| row2 | BIT STRING (SIZE (12)) |

},

| | |
|---|---|
| firstOFDMSymbolInTimeDomain | INTEGER (0..13), |
| sequenceGenerationConfig | INTEGER (0..1023), |

```
  ...,
  [[
```

| | |
|---|---|
| slotConfig-r17 | CHOICE { |
| ms4 | INTEGER (0..255), |
| ms5 | INTEGER (0..319), |
| ms10 | INTEGER (0..639), |
| ms20 | INTEGER (0..1279), |
| ms40 | INTEGER (0..2559) |

| | |
|---|---|
| } | OPTIONAL -- Need R |

]]
}

| | |
|---|---|
| CSI-RS-Index ::= | INTEGER (0..maxNrofCSI-RS-ResourcesLTM−1) |
| LTM-CSI-ReportConfig-r18 ::= | SEQUENCE { |

| | |
|---|---|
| ltm-CSI-ReportConfigId-r18 | LTM-CSI-ReportConfigId-r18, |

| | |
|---|---|
| ltm-ResourcesForChannelMeasurement-r18 | LTM-CSI-ResourceConfigId-r18, |

| | |
|---|---|
| ltm-ReportConfigType-r18 | CHOICE { |
| periodic-r18 | SEQUENCE { |

| | |
|---|---|
| reportSlotConfig-r18 | CSI-ReportPeriodicityAndOffset, |
| pucch-CSI-ResourceList-r18 | SEQUENCE (SIZE (1..maxNrofBWPs)) OF |

PUCCH-CSI-Resource
},

| | |
|---|---|
| semiPersistentOnPUCCH-r18 | SEQUENCE { |
| reportSlotConfig-r18 | CSI-ReportPeriodicityAndOffset, |
| pucch-CSI-ResourceList-r18 | SEQUENCE (SIZE (1..maxNrofBWPs)) OF |

PUCCH-CSI-Resource
},

| | |
|---|---|
| semiPersistentOnPUSCH-r18 | SEQUENCE { |
| reportSlotConfig-r18 | CSI-ReportPeriodicityAndOffset, |
| reportSlotOffsetList-r18 | SEQUENCE (SIZE (1.. maxNrofUL- |

Allocations-r16)) OF INTEGER (0..128),

| | |
|---|---|
| reportSlotOffsetListDCI-0-2-r18 | SEQUENCE (SIZE (1.. maxNrofUL- |

Allocations-r16)) OF INTEGER (0..128),

| | |
|---|---|
| reportSlotOffsetListDCI-0-1-r18 | SEQUENCE (SIZE (1.. maxNrofUL- |

Allocations-r16)) OF INTEGER (0..128),

| | |
|---|---|
| p0alpha | P0-PUSCH-AlphaSetId |

},

| | |
|---|---|
| aperiodic-r18 | SEQUENCE { |

| | |
|---|---|
| reportSlotOffsetList-r18 | SEQUENCE (SIZE (1.. maxNrofUL- |

Allocations-r16)) OF INTEGER (0..128),

| | |
|---|---|
| reportSlotOffsetListDCI-0-2-r18 | SEQUENCE (SIZE (1.. maxNrofUL- |

Allocations-r16)) OF INTEGER (0..128),

| | |
|---|---|
| reportSlotOffsetListDCI-0-1-r18 | SEQUENCE (SIZE (1.. maxNrofUL- |

```
Allocations-r16)) OF INTEGER (0..128)
      },
      ...
      [[
```

| | |
|---|---|
| condEvent-r19 | SEQUENCE { |
| condEventId | CHOICE { |
| condEventA3 | SEQUENCE { |
| a3-Offset | MeasTriggeredQuantityOffset, |
| hysteresis | Hysteresis, |
| timeToTrigger | TimeToTrigger |

},

| | |
|---|---|
| condEventA5 | SEQUENCE { |
| a5-Threshold1 | MeasTriggerQuantity, |
| a5-Threshold2 | MeasTriggerQuantity, |
| hysteresis | Hysteresis, |
| timeToTrigger | TimeToTrigger |

```
            },
            ...,
```

| | |
|---|---|
| condEventA4 | SEQUENCE { |
| a4-Threshold-r17 | MeasTriggerQuantity, |
| hysteresis-r17 | Hysteresis, |
| timeToTrigger-r17 | TimeToTrigger |

},

| | |
|---|---|
| condEventD1 | SEQUENCE { |

```
              distanceThreshFromReference1-r17 INTEGER(0.. 65525),
              distanceThreshFromReference2-r17 INTEGER(0.. 65525),
```

| | |
|---|---|
| referenceLocation1-r17 | ReferenceLocation-r17, |
| referenceLocation2-r17 | ReferenceLocation-r17, |
| hysteresisLocation-r17 | HysteresisLocation-r17, |
| timeToTrigger-r17 | TimeToTrigger |

},

| | |
|---|---|
| condEventT1 | SEQUENCE { |
| t1-Threshold-r17 | INTEGER (0..549755813887), |
| duration-r17 | INTEGER (1..6000) |

},

| | |
|---|---|
| condEventD2 | SEQUENCE { |

```
              distanceThreshFromReference1-r18 INTEGER(0.. 65535),
              distanceThreshFromReference2-r18 INTEGER(0.. 65535),
```

| | |
|---|---|
| hysteresisLocation-r18 | HysteresisLocation-r17, |
| timeToTrigger-r18 | TimeToTrigger |

},

| | |
|---|---|
| condEventD1T1 | SEQUENCE { |

distanceThreshFromReference1-r17 INTEGER(0.. 65525),

| | |
|---|---|
| referenceLocation1-r17 | ReferenceLocation-r17, |
| hysteresisLocation-r17 | HysteresisLocation-r17, |
| timeToTrigger-r17 | TimeToTrigger |
| t1-Threshold-r17 | INTEGER (0..549755813887), |
| duration-r17 | INTEGER (1..6000) |

}

| | |
|---|---|
| condEventD1T2 | SEQUENCE { |

distanceThreshFromReference1-r17 INTEGER(0.. 65525),

| | |
|---|---|
| referenceLocation1-r17 | ReferenceLocation-r17, OPTIONAL -- Need R |
| referenceTime-r17 | EpochTime-r17, OPTIONAL -- Need R |
| hysteresisLocation-r17 | HysteresisLocation-r17, |
| timeToTrigger-r17 | TimeToTrigger |
| t1-Threshold-r17 | INTEGER (0..549755813887), |
| duration-r17 | INTEGER (1..6000) |

```
            }
        }
      }
      ]]
  },
```

| | |
|---|---|
| ltm-ReportContent-r18 | LTM-ReportContent-r18, |

...
}
SatConfig-r19::= SEQUENCE {

| | |
|---|---|
| satConfigID-r19 | SatelliteID, |
| satAssistanceInfo-r19 | NTN-Config-r19, |

...
}
SatelliteID::= INTEGER (1..maxNrofSatellites-r19)

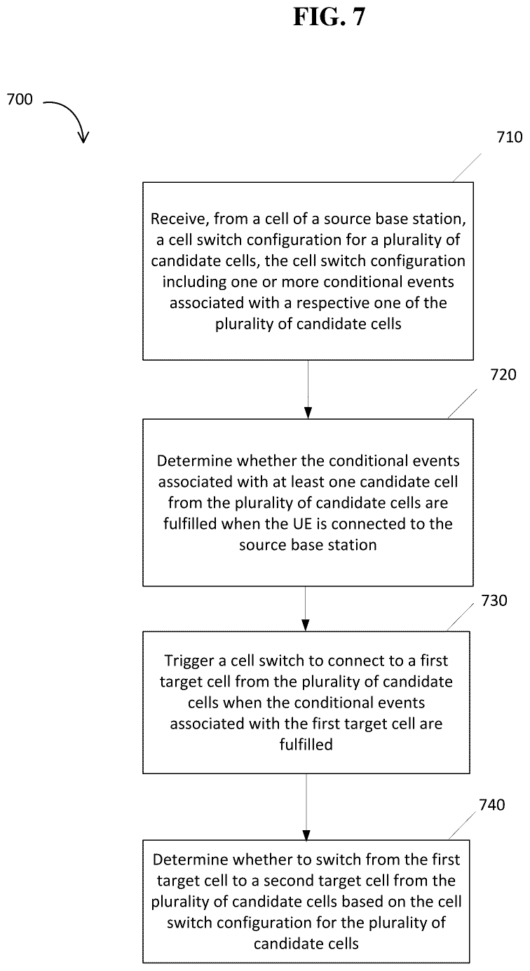

FIG. 7 shows an example process 700 for a UE that evaluates execution conditions for multiple candidate cells and executes successive cell switch to multiple candidate cells autonomously when the corresponding execution conditions are met in accordance with an embodiment. For explanatory and illustration purposes, the example processes 700 may be performed by a UE (e.g., UE 111-116 as described with reference to FIG. 1). Although one or more operations are described or shown in particular sequential order, in other embodiments the operations may be rearranged in a different order, which may include performance of multiple operations in at least partially overlapping time periods.

Referring to FIG. 7, the process 700 may begin in operation 710. In operation 710, a UE (e.g., a processor of the UE) receives from a cell of a source base station a cell switch configuration for a plurality of candidate cells. The cell switch configuration includes one or more conditional events associated with a respective one of the plurality of candidate cells.

In operation 720, the UE determines whether the conditional events associated with at least one candidate cell from the plurality of candidate cells are fulfilled when the UE is connected to the source base station. In one embodiment, the conditional events associated with a candidate cell may include a beam measurement of the candidate cell, a location event of the candidate cell, and/or a time event of the candidate cell.

In operation 730, the UE triggers a cell switch to connect to a first target cell from the plurality of candidate cells when the conditional events associated with the first target cell are fulfilled.

In operation 740, the UE determines whether to switch from the first target cell to a second target cell from the plurality of candidate cells based on the cell switch configuration for the plurality of candidate cells.

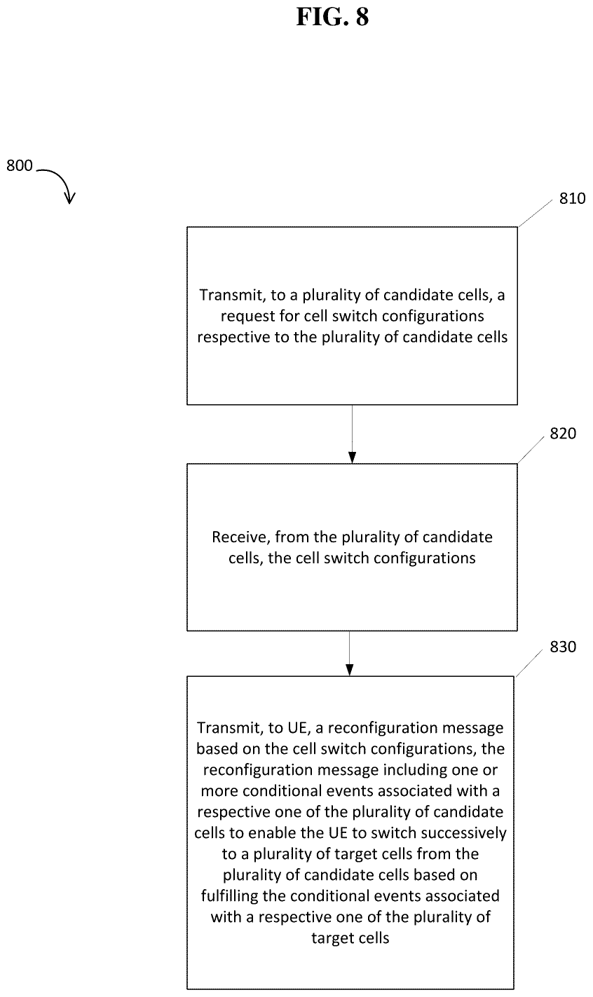

FIG. 8 shows an example process 800 for a base station to configure a UE with execution conditions for multiple candidate cells to enable the UE to execute successive cell switch in accordance with an embodiment. For explanatory and illustration purposes, the example processes 800 may be performed by a base station (or gNBs) (e.g., BS 101-103 as described with reference to FIG. 1). Although one or more operations are described or shown in particular sequential order, in other embodiments the operations may be rearranged in a different order, which may include performance of multiple operations in at least partially overlapping time periods.

Referring to FIG. 8, the process may begin in operation 810. in operation 810, the base station (e.g., a transceiver of the base station) transmits to a plurality of candidate cells a request for cell switch configurations respective to the plurality of candidate cells.

In operation 820, the base station receives the cell switch configuration from the plurality of candidate cells.

In operation 830, the base station transmits to a UE a reconfiguration message based on the cell switch configurations. The reconfiguration message includes one or more conditional events associated with a respective one of the plurality of candidate cells. The reconfiguration message enables the UE to switch successively to a plurality of target cells from the plurality of candidate cells based on fulfilling the conditional events associated with a respective one of the plurality of target cells.

The disclosure presents a mechanism where the UE evaluates execution condition(s) for one or multiple candidate cells and the UE executes the cell switch autonomously to a candidate cell when the corresponding execution condition is met. The procedure, referred to as successive conditional cell switch, enables the UE to execute successive cell switch without configuration release or reconfiguration between cell switching. It is applicable to frequent cell switching in high UE mobility scenarios or in NTN deployment scenarios. Advantageously, by providing a mechanism for the UE to evaluate execution conditions and execute cell switch multiple times for successive cell switch without releasing cell switch configurations after each cell switch completion, the procedure reduces latency, signaling overhead and interruption time associated with successive cell switching.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) in a wireless network, the UE comprising:
a processor configured to:
receive, from a cell of a source base station, a cell switch configuration for a plurality of candidate cells, the cell switch configuration including one or more conditional events associated with a respective one of the plurality of candidate cells;
determine whether the conditional events associated with at least one candidate cell from the plurality of candidate cells are fulfilled when the UE is connected to the source base station;
trigger a cell switch to connect to a first target cell from the plurality of candidate cells when the conditional events associated with the first target cell are fulfilled; and
determine whether to switch from the first target cell to a second target cell from the plurality of candidate cells based on the cell switch configuration for the plurality of candidate cells.

2. The UE of claim 1, wherein the cell switch configuration comprises the conditional events associated with the first target cell and the conditional events associated with the second target cell, and wherein to determine whether to switch from the first target cell to the second target cell, the processor is configured to:
determine whether the conditional events associated with the second target cell are fulfilled when the UE is connected to the first target cell.

3. The UE of claim 1, wherein the conditional events associated with a candidate cell of the plurality of candidate cells comprises at least one of:
a beam measurement event of the candidate cell;
a location event of the candidate cell; or
a time event of the candidate cell.

4. The UE of claim 3, wherein the beam measurement event of the candidate cell comprises:
a beam measurement of the candidate cell is better than a beam measurement of a connected cell of the UE by a configured amount;
the beam measurement of the candidate cell is better than a first configured threshold; or
the beam measurement of the connected cell of the UE is worse than a second configured threshold and the beam measurement of the candidate cell is better than a third configured threshold.

5. The UE of claim 4, wherein to determine whether the conditional events associated with the at least one candidate cell are fulfilled, the processor is configured to:
receive, from the cell of the source base station, a measurement configuration for a resource of the at least one candidate cell; and
determine whether a measurement of the resource of the at least one candidate cell based on the measurement configuration satisfies the beam measurement event of the at least one candidate cell.

6. The UE of claim 3, wherein the location event of the candidate cell comprises:
a distance measurement of the UE from a reference location is larger than a first configured distance threshold and a distance measurement of the UE from the candidate cell is less than a second configured distance threshold;
a distance measurement of the UE from a moving location of a connected cell of the UE is larger than a third configured distance threshold and a distance measurement of the UE from a moving location of the candidate cell is less than a fourth configured distance threshold;
a distance measurement of the UE from a reference location of the candidate cell is less than a fifth configured distance threshold; or
a distance measurement of the UE from the moving location of the candidate cell is less than a sixth configured distance threshold.

7. The UE of claim 3, wherein the time event of the candidate cell comprises:
a measured time of the UE is more than a configured time threshold and the measured time is less than a sum of the configured time threshold and a configured duration.

8. The UE of claim 1, wherein the source base station and the plurality of candidate cells are part of a non-terrestrial network.

9. The UE of claim 1, wherein the processor is further configured to:
perform a downlink or an uplink synchronization with a candidate cell of the plurality of candidate cells before the cell switch.

10. A method performed by a user equipment (UE) in a wireless network, the method comprising:
receiving, from a cell of a source base station, a cell switch configuration for a plurality of candidate cells, the cell switch configuration including one or more conditional events associated with a respective one of the plurality of candidate cells;
determining whether the conditional events associated with at least one candidate cell from the plurality of candidate cells are fulfilled when the UE is connected to the source base station;
triggering a cell switch to connect to a first target cell from the plurality of candidate cells when the conditional events associated with the first target cell are fulfilled; and
determining whether to switch from the first target cell to a second target cell from the plurality of candidate cells based on the cell switch configuration for the plurality of candidate cells.

11. The method of claim 10, wherein the cell switch configuration comprises the conditional events associated with the first target cell and the conditional events associated with the second target cell, and wherein determining whether to switch from the first target cell to the second target cell comprises:
determining whether the conditional events associated with the second target cell are fulfilled when the UE is connected to the first target cell.

12. The method of claim 10, wherein the conditional events associated with a candidate cell of the plurality of candidate cells comprises at least one of:
a beam measurement event of the candidate cell;
a location event of the candidate cell; or
a time event of the candidate cell.

13. The method of claim 12, wherein the beam measurement event of the candidate cell comprises:
a beam measurement of the candidate cell is better than a beam measurement of a connected cell of the UE by a configured amount;
the beam measurement of the candidate cell is better than a first configured threshold; or
the beam measurement of the connected cell of the UE is worse than a second configured threshold and the beam measurement of the candidate cell is better than a third configured threshold.

14. The method of claim 13, wherein determining whether the conditional events associated with the at least one candidate cell are fulfilled comprises:
receiving, from the cell of the source base station, a measurement configuration for a resource of the at least one candidate cell; and
determining whether a measurement of the resource of the at least one candidate cell based on the measurement configuration satisfies the beam measurement event of the at least one candidate cell.

15. The method of claim 12, wherein the location event of the candidate cell comprises:
a distance measurement of the UE from a reference location is larger than a first configured distance threshold and a distance measurement of the UE from the candidate cell is less than a second configured distance threshold;
a distance measurement of the UE from a moving location of a connected cell of the UE is larger than a third configured distance threshold and a distance measurement of the UE from a moving location of the candidate cell is less than a fourth configured distance threshold;
a distance measurement of the UE from a reference location of the candidate cell is less than a fifth configured distance threshold; or
a distance measurement of the UE from the moving location of the candidate cell is less than a sixth configured distance threshold.

16. The method of claim 12, wherein the time event of the candidate cell comprises:
a measured time of the UE is more than a configured time threshold and the measured time is less than a sum of the configured time threshold and a configured duration.

17. The method of claim 10, wherein the source base station and the plurality of candidate cells are part of a non-terrestrial network.

18. The method of claim 10, further comprising:
performing a downlink or an uplink synchronization with a candidate cell of the plurality of candidate cells before the cell switch.

19. A base station of a wireless network, the base station comprising:
a transceiver configured to:
transmit, to a plurality of candidate cells, a request for cell switch configurations respective to the plurality of candidate cells;
receive, from the plurality of candidate cells, the cell switch configurations; and
transmit, to a user equipment (UE), a reconfiguration message based on the cell switch configurations, the reconfiguration message including one or more conditional events associated with a respective one of the plurality of candidate cells to enable the UE to switch successively to a plurality of target cells from the plurality of candidate cells based on fulfilling the conditional events associated with a respective one of the plurality of target cells.

20. The base station of claim 19, wherein the reconfiguration message comprises conditional events associated respectively with a first target cell and a second target cell from the plurality of candidate cells, wherein the conditional events associated with the first target cell enables the UE to switch to the first target cell when the UE is connected with the base station, and wherein the conditional events associated with the second target cell enables the UE to switch to the second target cell when the UE is connected with the first target cell.
